(19) United States
(12) Patent Application Publication
(10) Pub. No.: US 2010/0060944 A1
(43) Pub. Date: Mar. 11, 2010

(54) METHODS OF PROTECTING SECURITY DOCUMENTS FROM COUNTERFEITING

(75) Inventors: Patrick Swift, Victoria (AU); Gary Fairless Power, Victoria (AU)

Correspondence Address: BARNES & THORNBURG LLP, 750-17TH STREET NW, SUITE 900, WASHINGTON, DC, 20006-4675, US

(73) Assignee: SECURENCY INTERNATIONAL PTY LTD, Craigieburn, Victoria (AU)

(21) Appl. No.: 12/514,624

(22) PCT Filed: Nov. 14, 2007
(86) PCT No.: PCT/AU2007/001750

§ 371 Date: Jul. 1, 2009

(30) Foreign Application Priority Data
Nov. 14, 2006 (AU) 2006906364

(51) Int. Cl. H04N 1/40; G06K 9/00

(52) U.S. Cl. 358/3.28; 382/100

(57) ABSTRACT

A method of protecting a security document from counterfeiting includes applying at least one security element containing a concealed Fourier pattern to the document. The concealed Fourier pattern is produced from a master Fourier profile, and is applied to the document by embossing, engraving, laser ablation or chemical etching, and/or by a cylinder or plate bearing the master Fourier profile. When a counterfeit security document produced without knowledge of the master Fourier profile is scanned or imaged and subjected to a Fourier transform, the resulting test Fourier pattern will differ from a master Fourier pattern corresponding to the master Fourier profile for the authentic security document. In a particular embodiment, the concealed Fourier pattern is applied to the document by rotogravure printing.

### CROSS-REFERENCE TO RELATED APPLICATIONS

The present application claims the benefit of priority to International Patent Application No. PCT/AU2007/001750 filed 14 Nov. 2007, which claims priority to Australian Patent Application No. 2006906364 filed 14 Nov. 2006, the contents of which are incorporated herein by reference in their entirety.

### FIELD OF THE INVENTION

This invention relates to methods of protecting documents and tokens from counterfeiting, to security documents or tokens, which are protected from counterfeiting, and to methods of determining the authenticity of documents and tokens.

### BACKGROUND TO THE INVENTION

It is known to provide security documents, such as banknotes or the like, with a wide variety of security elements which can provide verification of authenticity and protection against copying and counterfeiting. Such security elements include overt security elements which are visible to observers, but difficult to reproduce, such as security threads, strips and holograms, and covert security elements which may be concealed or embedded within the security document, such as fluorescent inks or taggants and which are only detectable using particular equipment or when the document is exposed to light of a particular wavelength, e.g. UV light. However, many different types of overt and covert security elements can be expensive to produce and/or can require relatively expensive equipment for authentication.

It is, therefore, desirable to provide a method of testing the authenticity of documents or tokens which does not require expensive security elements that substantially increase the cost of manufacture of the documents.

It is also desirable to provide a security document or token which is protected from counterfeiting by at least one covert security element that is difficult to reproduce by photocopying or printing.

### SUMMARY OF THE INVENTION

According to one aspect of the invention, there is provided a method of protecting a security document from counterfeiting comprising applying at least one security element containing a concealed Fourier pattern to the document wherein the concealed Fourier pattern is produced from a master Fourier profile and wherein the concealed Fourier pattern is applied to the document by embossing, engraving, laser ablation or chemical etching, such that when a counterfeit security document produced without knowledge of the master Fourier profile is scanned and subjected to a Fourier transform, the resulting Fourier pattern differs from a master Fourier pattern corresponding to the master Fourier profile for the authentic security document.

According to another aspect of the invention there is provided a security document protected from counterfeiting comprising a substrate and including at least one security element, wherein the security element contains a concealed Fourier pattern produced from a master Fourier profile and wherein the concealed Fourier pattern is applied to the document by embossing, engraving, laser ablation or chemical etching, such that when a counterfeit document is produced without knowledge of the master Fourier profile and the counterfeit document is scanned and subjected to a Fourier transform, a test Fourier pattern is produced which differs from a master Fourier pattern corresponding to the master Fourier profile.

According to another aspect of the invention, there is provided a method of protecting a security document from counterfeiting comprising applying at least one security element containing a concealed Fourier pattern to the document wherein the concealed Fourier pattern is produced from a master Fourier profile and wherein the concealed Fourier pattern is applied to the document by a cylinder or plate bearing the master Fourier profile, such that when a counterfeit security document produced without knowledge of the master Fourier profile is scanned and subjected to a Fourier transform, the resulting Fourier pattern differs from a master Fourier pattern corresponding to the master Fourier profile for the authentic security document.

According to another aspect of the invention there is provided a security document protected from counterfeiting comprising a substrate and including at least one security element, wherein the security element contains a concealed Fourier pattern produced from a master Fourier profile and wherein the concealed Fourier pattern is applied to the document by a cylinder or plate bearing the master Fourier profile, such that when a counterfeit document is produced without knowledge of the master Fourier profile and the counterfeit document is scanned and subjected to a Fourier transform, a test Fourier pattern is produced which differs from a master Fourier pattern corresponding to the master Fourier profile.

According to a further aspect of the invention, there is provided a method of testing the authenticity of a document, wherein an authentic document is protected from the counterfeiting in accordance with either of the methods above and includes a security element containing a concealed Fourier pattern produced from a master Fourier profile, said method of testing including selecting an area of a document to be tested corresponding to where the security element is located on the authentic security document, scanning or imaging said selected area of the document to be tested, performing a Fourier transform on the scanned or imaged area to obtain a test Fourier pattern, and comparing the test Fourier pattern with a master Fourier pattern corresponding to the master Fourier profile to determine whether the document is authentic or a counterfeit.

The concealed Fourier pattern may be applied to the security document by printing, but it is possible that the Fourier pattern could be applied by other methods such as embossing or engraving, laser ablation or chemical etching. The concealed pattern may be [[is]] applied by a printing or embossing cylinder or plate bearing the master Fourier profile. The concealed Fourier pattern may be applied to the security document by rotogravure printing.

Rotogravure printing involves the use of a printing cylinder which is engraved with a pattern or image corresponding to the pattern or image to be printed on the substrate. The engraved pattern or image may comprise a plurality of small recessed cells that act as tiny ink wells. The depth and size of the cells control the amount of ink that is transferred to the substrate via a process of pressure, osmosis and electrostatic pull.

Rotogravure is sometimes confused with photogravure which is a type of intaglio printing that uses a flat copper plate etched deeply to provide a relief structure on the printed document which may have a variety of tones caused by the variable depth of etch on the photogravure printing plate. In contrast, a rotary cylinder used in rotogravure printing is only lightly engraved.

According to another aspect of the invention, there is provided a method of protecting a security document from counterfeiting comprising producing a rotogravure printing cylinder with a predetermined cell pattern providing a master Fourier profile, printing at least one layer of the security document with the rotogravure printing cylinder to form a concealed Fourier pattern corresponding to the predetermined cell pattern, wherein when a counterfeit security document produced without knowledge of the predetermined cell pattern is scanned or imaged and subjected to a Fourier transform, the resulting test Fourier pattern differs from a master Fourier pattern corresponding to the authentic security document protected from counterfeiting.

According to yet another aspect of the invention there is provided a security document protected from counterfeiting which is produced by the method above.

According to a still further aspect of the invention, there is provided a method of testing whether a document is an authentic document or a counterfeit copy, wherein the authentic document is produced in accordance with the method above and includes at least one layer applied to the document by printing with a rotogravure cylinder having a predetermined cell pattern providing a master Fourier profile, the method including performing a Fourier transform on a selected area of an authentic document to obtain a master Fourier pattern corresponding to the predetermined cell pattern of the rotogravure cylinder, scanning an area of a test document corresponding to the selected area of the authentic document, performing a Fourier transform on the scanned area of the test document to obtain a test Fourier pattern, and comparing the test Fourier pattern with the master Fourier pattern to determine whether the test document is authentic or a counterfeit copy of the authentic document.

The Fourier transform performed on the scanned area of the test document may be a Fast Fourier Transform (FFT). In one method of the invention, the concealed Fourier pattern represents a hidden message or image.

A Fourier transform, e.g., an inverse Fourier transform may be performed on the message or image to be hidden within the concealed Fourier pattern, and the transformed message or image may be engraved on the printing cylinder or plate for printing onto the security document.

In another embodiment, an engraved rotogravure printing cylinder having a predetermined engraved pattern may be used to produce a concealed Fourier pattern or image on a printed document, the Fourier pattern being known only to the authorised manufacturer of the security document.

If a counterfeiter attempts to copy or reproduce an authentic security document without knowledge of the predetermined engraved pattern on the printing cylinder, the counterfeit copy is readily detectable by the method of the present invention. For example, a counterfeit copy produced by photocopying or another form of printing either will not produce a Fourier pattern or image during testing or will not produce the same test Fourier image or pattern as the master Fourier image or pattern of the authentic security document. Even if the counterfeit document is produced by rotogravure printing, it will still be detectable as a fake because any slight variations to the size, spacing or frequency of the predetermined cell pattern of the authentic rotogravure cylinder will produce a different Fourier pattern or image.

A security document protected from counterfeiting in accordance with the invention may be formed from a substrate of plastics material, and more specifically from a transparent polymeric material. However, the invention is also applicable to documents formed from substrate of other materials, such as paper or fibrous materials, and to laminated substrates.

A plurality of security elements, each including a concealed Fourier pattern or image, may be applied to the authentic security document to provide greater security to the document. The plurality of security elements may be applied at different locations on the security document. Alternatively or additionally, the plurality of security elements may be applied in different layers of the security document.

For example, when the security document is formed from a substrate of transparent polymeric material to which one or more layers of opacifying material are applied, at least one security element including a concealed Fourier pattern or image may be applied to the polymeric substrate, in or to the at least one opacifying layer and/or may be formed in a printed layer applied to the substrate or to an opacifying layer.

### BRIEF DESCRIPTION OF THE DRAWINGS

Further features of the present invention will be apparent to those skilled in the art from the following description of the illustrated embodiments of the invention. It will be understood, however, that the embodiments are not limiting of the scope of the invention as defined in any of the preceding statements. The embodiments are described with reference to the accompanying drawings, in which:

FIG. 1 is a schematic plan view of a security document according to the present invention;

FIG. 2 is a section of the line II-II of FIG. 1;

FIG. 3 shows an original image to be concealed as a Fourier pattern and the Fourier pattern of the image;

FIG. 4 shows an enlarged view of the concealed image area of FIG. 3;

FIG. 5 shows a FFT of the area in FIG. 4, displaying the concealed image of FIG. 3;

FIG. 6 shows a FFT of an area of Gravure printed substrate printed with a Gravure cylinder having a predetermined cell pattern;

FIG. 7 shows a FFT of a copy of the area of the Gravure printed substrate of FIG. 6;

FIG. 8 is a block diagram showing methods for protecting a security document from counterfeiting according to the present invention; and

FIG. 9 is a block diagram showing a method of testing a document for authenticity in accordance with the invention.

### DESCRIPTION OF EMBODIMENTS

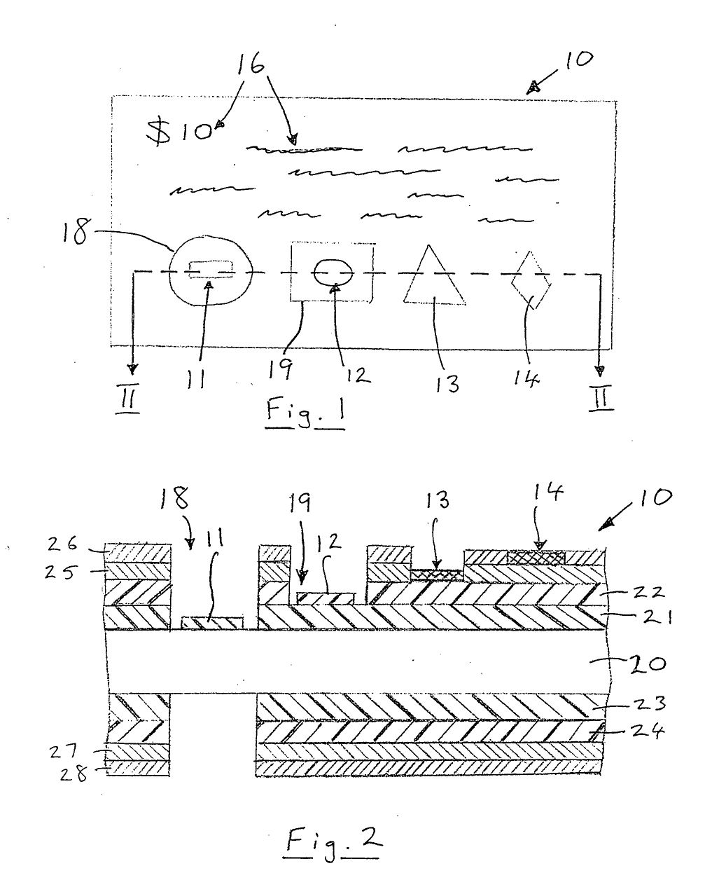

FIGS. 1 and 2 show a security document 10 provided with a plurality of security elements 11, 12, 13 and 14 in accordance with an embodiment of the invention. Each of the security elements 11-14 contains a concealed Fourier pattern or image, and the security elements 11-14 may be applied to the security document by rotogravure printing at different locations and in different layers of the document. The security document 10 is also provided with indicia 16, which may be printed or embossed on the security document in any one or more of a number of different methods, including: offset, flexographic, inkjet and intaglio printing.

The security document 10 has a substrate 20 which may be formed from one or more layers of a transparent polymeric material, such as biaxially oriented polypropylene. It will, however, be appreciated that other substrates may be used in the invention, such as polyethylene, polyethylene terephthalate (PET), or even substrates of paper or fibrous material.

As shown in FIG. 2, opacifying layers 21, 22 are applied to one side of the substrate 20, and further opacifying layers 23, 24 are applied to the opposite side of the substrate 20. The opacifying layers 21-24 are omitted on both sides of the substrate 20 in one region to form a window area 18 in which the first security element 11 is provided, and the opacifying layer 22 on one side of the substrate 20 is partly omitted in another region to form a second area 19 in which the second security element 12 is provided.

The opacifying layers 21-24 may comprise any one or more of a variety of opacifying coatings. The opacifying coatings may be adapted for printing with a rotogravure printing cylinder, and one form of coating comprises a pigment, such as titanium dioxide, dispersed with a binder or carrier of cross-linkable polymeric material.

The security document 10 also has printed ink layers 25, 26 applied to the opacifying layers 21, 22 on one side of the substrate 20 and further printed ink layers 27, 28 applied to the opacifying layers 23, 24 on the opposite side of the substrate 10 which may be used to provide the printed indicia 16. At least one of the printed ink layers 25, 26 may be applied by rotogravure printing.

As shown in FIG. 2, the first security element 11, is formed by applying the opacifying coating 21 to the surface of the substrate 20 in the window area 18; and the second security element 12 is formed by applying the opacifying coating 22 on the first opacifying layer 21 in area 19. The third security element 13 is formed by printing on the surface of the opacifying coating 22 and the fourth security element 14 is formed by printing on the first printed ink layer 25.

Each of the security elements includes a concealed Fourier pattern of a predetermined master image or pattern which may be determined by the engraved pattern on a rotogravure printing cylinder used to print the security element.

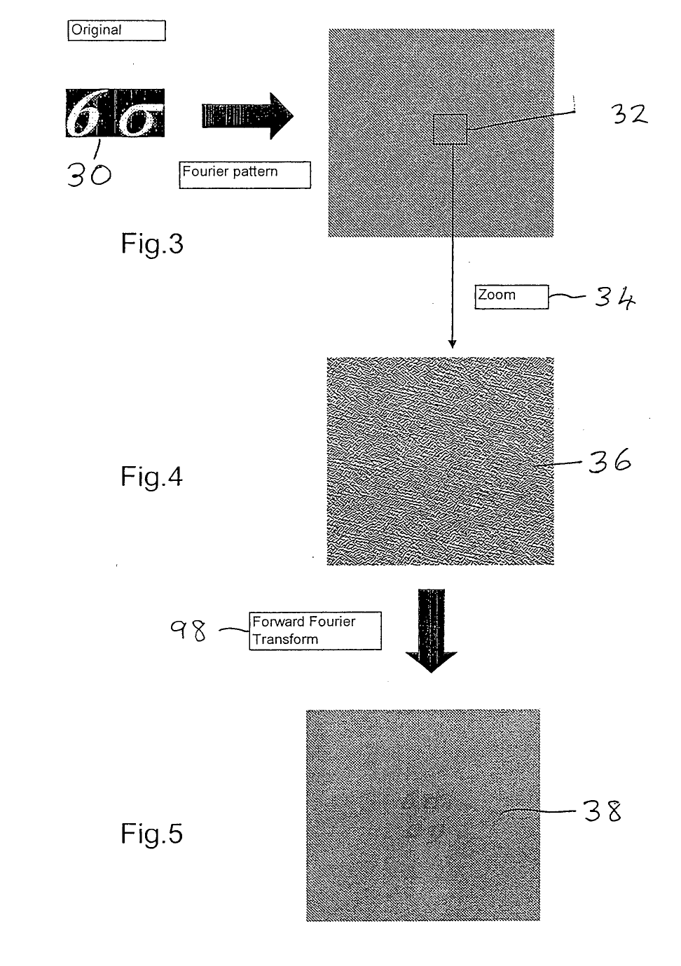

Different methods of forming the concealed Fourier pattern or images and subsequently testing the authenticity of a security document to determine whether it is an authentic document provided with the concealed Fourier pattern or image will now be described with reference to FIGS. 3 to 9.

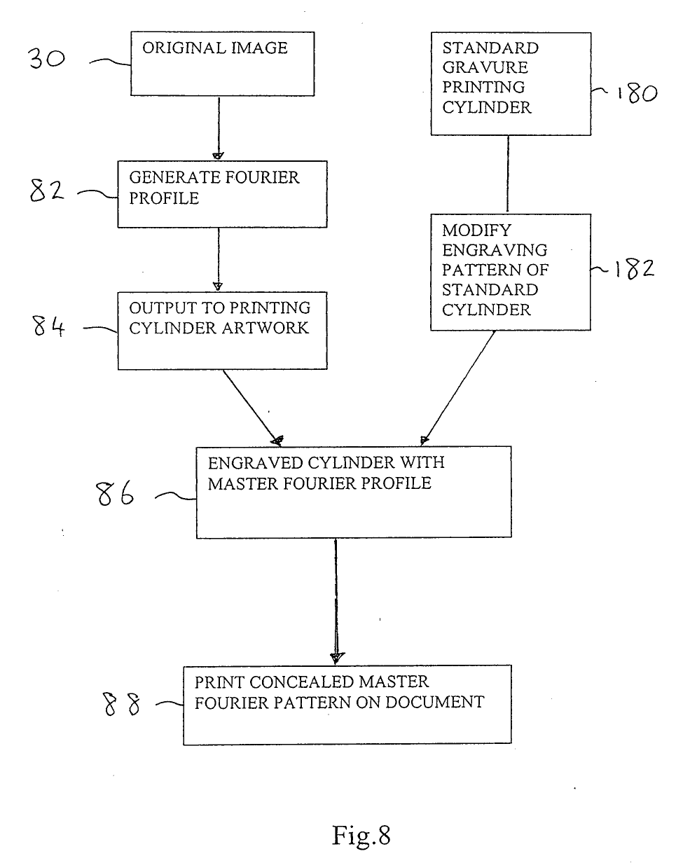

Referring to FIGS. 3 and 8, an original image 30 to be concealed as a Fourier pattern in a security document is subjected to a Fourier transform, e.g. an inverse Fourier transform, to generate a Fourier profile (step 82). The Fourier profile is output to a software program for generating artwork for an engraving profile of a rotogravure printing cylinder (step 84). The rotogravure printing cylinder is either engraved or etched with the profile which includes the master Fourier profile corresponding to the original image (step 86), and the security document 10 is then printed with the concealed master Fourier pattern (step 88), an example of the concealed master Fourier pattern 32 being shown in FIG. 3.

One method of generating the Fourier profile for the rotogravure printing cylinder for printing the concealed Fourier pattern or image is to produce an inverse Fourier transform of the required pattern or image. This may be superposed onto a background region so that the concealed Fourier pattern printed from the Fourier profile is not distinguishable from the background region to the human eye and is concealed in the background region.

Referring to FIGS. 4, 5 and 9, a test document 90 may be tested to determine the authenticity of the document in the following manner. An image area of the document where the concealed image is contained in an authentic note is scanned or imaged (step 92), for example by a scanner, camera, CCD or bank note acceptor. The image is digitized and may be manipulated, e.g., to produce a grey scale image 94, and a selected area of the image 96 corresponding to where the concealed Fourier pattern is located in an authentic document may be enlarged in a zoom operation (34 in FIG. 4) to obtain the enlarged grey scale image 36 shown in FIG. 4. A FFT is performed (step 98) on the image 36 and the image is combined with the known phase information for the concealed Fourier pattern to obtain a test Fourier pattern 100. The test Fourier pattern 100 is compared (step 102) with a master Fourier pattern or master image 104, and a decision algorithm to determine whether the test pattern is the same as the master 106, and if so the test document 90 is genuine 108.

FIG. 5, shows a Fourier pattern 38 obtained by performing the steps above on an authentic security document containing a concealed Fourier pattern 32 of an original image 30 of the symbols 6σ. It will be seen from FIG. 5 that the resulting Fourier pattern 38 also contains the symbols 6σ.

If the decision algorithm 102,106 determines that the test Fourier pattern 100 is not the same as the master, the test document 90, is determined to be counterfeit 110. For example, if the counterfeit document has been produced by photocopying or by other forms of printing than rotogravure printing, although the images on the counterfeit document visible to the human eye may appear the same as those of an authentic document, the concealed Fourier pattern of the authentic document will not be reproduced and the counterfeit document will be detected by the method described above. Further, even if the counterfeit document has been produced by rotogravure printing, even very slight differences in the engraving pattern on the rotogravure cylinder from the original cylinder used to produce the authentic document will result in a test Fourier pattern which differs from the master Fourier pattern or image.

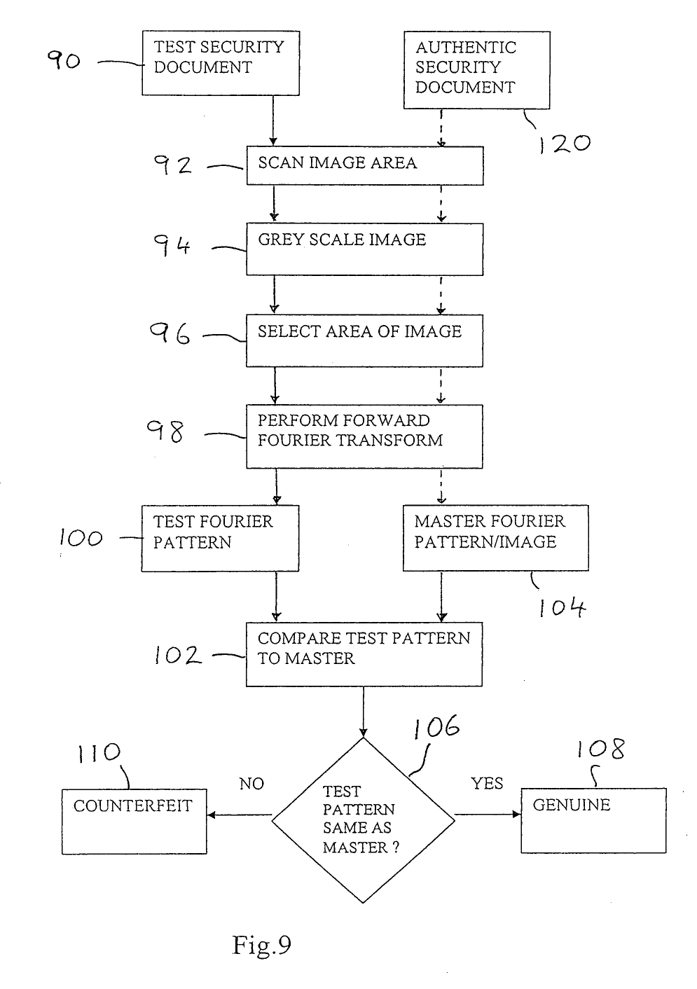

Several of the steps of the method of FIG. 9 may be performed with standard imaging software, such as Adobe® Photoshop which provides the facility for scanning, grey scaling and enlarging. Fourier transforms on images can also be performed in image analysis packages such as Image Pro. Therefore, the method of testing whether a security document is authentic or counterfeit can be performed and incorporated within equipment such as bank note acceptors at a relatively low cost. However, security documents produced with concealed Fourier images have an enhanced level of security provided the security of the rotogravure printing cylinders used to produce the concealed Fourier images is tightly controlled, e.g., by a central banknote issuing authority. The master Fourier pattern or image 104 for comparison with the test Fourier pattern may be provided to the person or organisation performing the test for authenticity in the form of an image supplied by the authority issuing the security document, or in hardware or software for performing the comparison.

Alternatively, an authentic security document 120 may be provided to the testing organisation which is subjected to the steps 92-98 described with reference to FIG. 9 to obtain the master Fourier pattern or image 104.

The security of authentic documents in accordance with the invention may be further increased by the manner in which the concealed Fourier pattern is incorporated within the document. The Fourier pattern may be concealed within a background. For example, in the security document of FIGS. 1 and 2, the background may be provided by the first opacifying layer 21 with the security element 12 containing the concealed Fourier pattern provided by an area of the second opacifying layer 22 with both opacifying layers 21, 22 appearing the same colour to the naked eye, e.g., uniformly white. The security element containing the concealed Fourier pattern may include a design which masks the Fourier pattern, for example when the security element 13, 14 is formed in one of the printed layers 25, 26, although the opacifying layers 21, 22 forming the security element 11, 12 of FIG. 2 may also be printed in shapes or designs, which mask the concealed Fourier patterns of the security elements.

It will also be appreciated that the concealed Fourier patterns may represent a wide variety of images, designs, patterns and messages, and any combinations thereof. It is a particular advantage that different images, designs, patterns and messages may be provided in different security documents. For example, in the case of banknotes, different denominations can contain different images or messages. Further, the ability to provide a plurality of different concealed Fourier patterns in different layers of a multi-layer security document increases the protection of the document from counterfeiting.

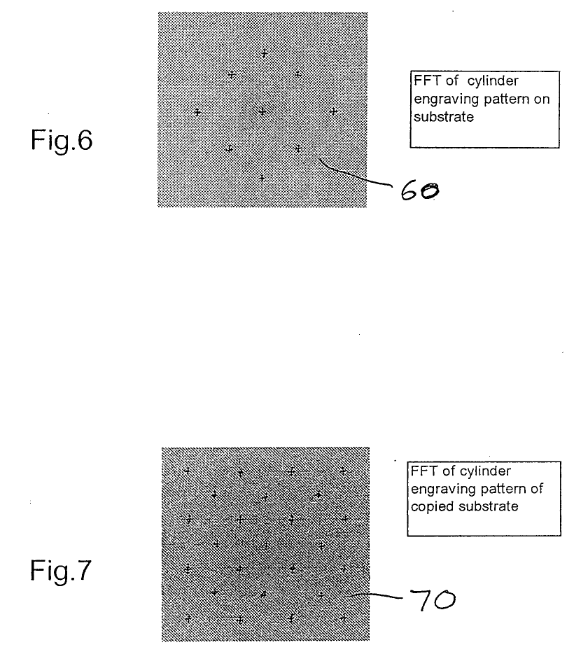

An alternative embodiment of the invention will now be described with reference to FIGS. 6-9. An engraved rotogravure printing cylinder is produced with an engraved cell pattern that has a predetermined Fourier profile, either by performing steps 82-86 of FIG. 8 or by taking a standard rotogravure printing cylinder 180 and modifying the engraving pattern (step 182) to produce the engraved cylinder with the master Fourier profile 86. The engraved cylinder 86 is then used to print the concealed master Fourier pattern as one or more security elements in one or more layers of authentic security elements.

Authentic security documents printed with the concealed master Fourier pattern and counterfeit copies produced without using the same rotogravure printing cylinder may be tested for authenticity using the same method described with reference to FIG. 9. Very slight modifications to the frequency or special distribution of the cells of the engraving pattern of the rotogravure printing cylinder 86 produce more significant changes to the Fourier profile of the rotogravure cylinder, and so; thus, even if a sophisticated counterfeiter uses a rotogravure printing cylinder in the production of counterfeits, the counterfeit copies will be readily detectable by comparison of the test Fourier pattern 104 of the authentic security document. By way of example, FIG. 6 shows a FFT 60 of an authentic security document produced by a rotogravure printing cylinder having a predetermined engraved Fourier profile, and FIG. 7 shows a FFT 70 of a copied document produced with a cylinder having a slightly different engraved Fourier profile. As with the first embodiment, banknotes of different denominations may be produced using rotogravure printing cylinders having a different predetermined master Fourier profiles.

In each of the embodiments described above, the testing equipment for determining the authenticity of security documents may be linked to a central database. This is particularly useful in the case of banknotes when soiled banknotes are collected after circulation. The soiled banknotes may be tested for authenticity using the Fourier analysis described above to determine the percentage of counterfeit documents in the soiled notes collected by the banknote issuing authority.

It will be appreciated that various modifications and alterations may be made to the various embodiments of the present invention described above without departing from the scope and spirit of the present invention. For example, whilst the embodiments of the drawings have been described with reference to security documents in the form of banknotes, it will be appreciated that the invention has application to a wide variety of other types of security and identification documents and tokens including, but not limited to the following: credit cards, cheques, identity cards, passports, securities and share certificates, drivers licences, deed of title, travel documents such as airline and train tickets, entrance cards and tickets, birth, death and marriage certificates, and academic transcripts.

1. A method of protecting a security document from counterfeiting comprising:
applying at least one security element containing a concealed Fourier pattern to the security document, wherein the concealed Fourier pattern is produced from a master Fourier profile, and wherein the concealed Fourier pattern is applied to the security document by printing or embossing,
whereby, when a counterfeit security document produced without knowledge of the master Fourier profile is scanned or imaged and subjected to a Fourier transform, the resulting test Fourier pattern differs from a master Fourier pattern corresponding to the master Fourier profile for the authentic security document.

2. A security document protected from counterfeiting comprising a substrate and including at least one security element, wherein the security element contains a concealed Fourier pattern produced from a master Fourier profile, and wherein the concealed Fourier pattern is applied to the security document by printing or embossing, such that when a counterfeit document is produced without knowledge of the master Fourier profile and the counterfeit security document is scanned or imaged and subjected to a Fourier transform, the resulting test Fourier pattern produced differs from a master Fourier pattern corresponding to the master Fourier profile.

3. A method of protecting a security document from counterfeiting comprising:
applying at least one security element containing a concealed Fourier pattern to the security document wherein the concealed Fourier pattern is produced from a master Fourier profile, and wherein the concealed Fourier pattern is applied to the security document by a cylinder or plate bearing the master Fourier profile,
whereby when a counterfeit security document produced without knowledge of the master Fourier profile is scanned or imaged and subjected to a Fourier transform, the resulting test Fourier pattern differs from a master Fourier pattern corresponding to the master Fourier profile for the authentic security document.

4. A security document protected from counterfeiting comprising a substrate and including at least one security element, wherein the security element contains a concealed Fourier pattern produced from a master Fourier profile, and wherein the concealed Fourier pattern is applied to the security document by a cylinder or plate bearing the master Fourier profile, such that when a counterfeit security document is produced without knowledge of the master Fourier profile and the counterfeit security document is scanned or imaged and subjected to a Fourier transform, the resulting test Fourier pattern produced differs from a master Fourier pattern corresponding to the master Fourier profile.

5. A method of testing the authenticity of a document, wherein an authentic security document is protected from counterfeiting by a security element containing a concealed Fourier profile produced from a master Fourier profile, the method comprising:
selecting an area of a document to be tested corresponding to where the security element is located on the authentic security document;
scanning or imaging said selected area of the document to be tested;
performing a Fourier transform on the scanned area to obtain a test Fourier pattern; and
comparing the test Fourier pattern with a master Fourier pattern corresponding to the master Fourier profile to determine whether the tested document is authentic or a counterfeit.

6. The method of claim 1, wherein the concealed Fourier pattern is applied by rotogravure printing.

7. A method of protecting a security document from counterfeiting comprising:
producing a rotogravure printing cylinder with a predetermined cell pattern providing a master Fourier profile; and
printing at least one layer of the security document with the rotogravure printing cylinder to form a concealed Fourier pattern corresponding to the predetermined cell pattern;
wherein when a counterfeit security document produced without knowledge of the predetermined cell pattern is scanned or imaged and subjected to a Fourier transform, the resulting test Fourier pattern differs from a master Fourier pattern corresponding to the an authentic security document protected from counterfeiting.

8. A security document protected from counterfeiting, the security document being produced by the method of claim 7.

9. A method of testing whether a document is an authentic document or a counterfeit copy, wherein the authentic document is produced in accordance with claim 1 and includes at least one layer applied to the document by printing with a rotogravure cylinder having a predetermined cell pattern providing a master Fourier profile, the method comprising:
performing a Fourier transform on a selected area of an authentic document to obtain a master Fourier pattern corresponding to the predetermined cell pattern of the rotogravure cylinder or plate;
scanning or imaging an area of a test document corresponding to the selected area of the authentic document;
performing a Fourier transform on the scanned or imaged area of the test document to obtain a test Fourier pattern; and
comparing the test Fourier pattern with the master Fourier pattern to determine whether the test document is authentic or a counterfeit copy of the authentic document.

10. The method of claim 1 wherein the Fourier transform performed to obtain the test Fourier pattern is a fast Fourier transform (FFT).

11. The method of claim 2 wherein the predetermined concealed Fourier pattern contains a hidden message or image.

12. The method of claim 11 wherein a Fourier transform is performed on an original message or image to generate the master Fourier profile used to form the concealed Fourier pattern containing the hidden message or image.

13. The method of claim 12 wherein the Fourier transform performed on the original message or image is an inverse Fourier transform.

14. The method of claim 12 wherein the master Fourier profile is output to a printing, embossing or engraving device for applying the concealed Fourier pattern to the authentic security document.

15. The method of claim 1 wherein a plurality of security elements, each including a concealed Fourier pattern, are applied to the security document.

16. The method of claim 15 wherein the plurality of security elements are applied to the security document at different locations.

17. The method of claim 15 wherein the plurality of security elements are applied in different layers of the security document.

18. The method of claim 1 wherein the substrate is formed from a plastics material.

19. The method of claim 18 wherein the security document is formed from a substrate of transparent polymeric material to which one or more layers of opacifying material are applied.

20. The method of claim 19 wherein said at least one security element including a concealed Fourier pattern is formed in or applied to the substrate of transparent polymeric material.

21. The method of claim 19 wherein at least one security element including a concealed Fourier pattern is formed in or applied to at least one opacifying layer applied to the polymeric substrate.

22. The method of claim 19 wherein at least one security element including a concealed Fourier pattern is formed in a printed layer applied to at least one of the opacifying layers.
